(19) United States
(12) Patent Application Publication
(10) Pub. No.: US 2025/0257799 A1
(43) Pub. Date: Aug. 14, 2025

(54) RADIAL SHAFT SEAL ARRANGEMENT

(71) Applicant: AKTIEBOLAGET SKF, GOTEBORG (SE)

(72) Inventors: Christoph PASSOW, Leichlingen (DE); Hans-Dieter ZANDER, Köln (DE); Wolfgang SWETE, Knittelfeld (AT)

(21) Appl. No.: 18/438,648

(22) Filed: Feb. 12, 2024

(30) Foreign Application Priority Data
Feb. 24, 2023 (DE) 102023201722.9

(51) Int. Cl. F16J 15/3244; F16J 15/3228

(52) U.S. Cl. CPC F16J 15/3244; F16J 15/3228

(57) ABSTRACT

A radial shaft seal element includes a support ring and a seal body mounted on the support ring. The seal body includes a sealing portion configured to assume a cylindrical shape and bear against a shaft to be sealed and to separate an air side of the radial shaft seal from an oil side of the radial shaft seal. The seal body has a distal end at the oil side and an annular projection configured to bear against the shaft around a circumference of the shaft and a recirculating structure between the annular projection and the distal end. An axial spacing between the annular projection and the recirculating structure varies between a minimum and a maximum, and the recirculating structure has at least one gap that may be located at a region of the minimum spacing.

### CROSS-REFERENCE

This application claims priority to German patent application no. 10 2023 201 722.9 filed on Feb. 24, 2023, the contents of which are fully incorporated herein by reference.

### TECHNOLOGICAL FIELD

The present invention relates to a radial shaft seal element configured for use with a shaft that rotates in forward and reverse directions.

### BACKGROUND

The disclosure is directed to a radial shaft seal element comprising a support ring on which at least one sealing lip is arranged, the sealing lip in some portions bearing with a cylindrical surface portion against a shaft to be sealed, in order to seal the shaft between an air side and an oil side.

Radial shaft seals are generally used in order to seal a shaft between an air side and an oil side. Such seals typically comprise a support ring on which at least one sealing lip is arranged, the sealing lip bearing in some portions against a shaft to be sealed. In electric drive trains, generally small electric motors are used with very high rotational speeds on the rotating shaft. Standard radial shaft sealing rings made of elastomers are not able to achieve the required tightness (sealing effect) due to the high rotational speed. The frictional heat generated by the seal damages the seal material at the contact point with the shaft. Thus it is necessary to reduce the contact force and to provide the seal with a certain recirculating pumping function which transports the arising leakage back into the system.

Sealing lips having flat contact portions, that is, cylindrical portions that contact the cylindrical shaft, and which are provided with a spiral-shaped groove or similar recirculating elements for the recirculation of oil, are known from the prior art. Depending on the material used for the sealing lip, such spiral-shaped grooves or similar recirculating elements can lead to a tightness problem in the static state.

A further drawback of the radial shaft seals known from the prior art is that they can only be used in one rotational direction. Brief reversing movements of the shaft, such as occur when a vehicle is reversing for example, can be accepted but the known radial shaft seals cannot be used in the opposing direction with the same performance.

### SUMMARY

Thus it is an aspect of the present disclosure to provide a radial shaft seal element which has an equal fluid recirculating effect in both rotational directions.

The radial shaft seal element comprises a support ring on which at least one is arranged. The seal body comprises a sealing portion which is configured to bear against a shaft to be sealed in order to seal the shaft between an air side and an oil side. The sealing portion has an annular projection which is configured to bear against the shaft over the circumference, wherein the annular projection is arranged adjacent to the air side. Moreover, the sealing portion comprises a recirculating structure, wherein the recirculating structure is arranged on the oil side of the annular projection. The support ring can preferably be produced from metal and/or from plastic, in particular from fiber-reinforced plastics.

For example, when sealing a chamber filled with oil or another liquid relative to the surrounding air by the seal element which is configured as a radial shaft sealing ring, a chamber side or oil side and an air side are defined relative to the sealing portion. When the shaft is rotating, for protection against wear, the recirculating structure can run on a thin oil film on the shaft and thus can be lubricated. As a result, it can potentially lead to the ingress of oil (leakage oil) or liquid so that the leakage oil passes into the region between the annular projection and the recirculating structure.

In order to recirculate the leakage oil again, the annular projection and the recirculating structure are arranged at a variable spacing to one another so that a spacing between the annular projection and the recirculating structure varies between a minimum spacing and a maximum spacing.

The recirculating structure has at least one gap which is arranged in a region of the minimum spacing. As long as the shaft is stationary, the region between the annular projection and the recirculating structure is filled with oil. As soon as the shaft rotates, the shaft entrains the oil. Due to the variable spacing between the annular projection and the recirculating structure, the oil is conveyed in the direction of the region with minimum spacing and thus to the at least one gap. As a result, excess oil can be removed from the region between the annular projection and the recirculating structure. The at least one gap can be retroactively incorporated, for example, in the recirculating structure. In other words, the recirculating structure can initially be applied as a continuous structure onto the sealing portion or the sealing portion can initially be formed by a continuous recirculating structure and then the at least one gap can then be incorporated in the recirculating structure in a post-machining step. For example, the at least one gap can be cut, milled, stamped or formed by another suitable method in the recirculating structure. Alternatively, the recirculating structure can be already formed with the gap.

Preferably, the seal body is produced from an elastomer material, in particular from a temperature-stable elastomer material. Alternatively, the seal body can be produced from PTFE. Advantageously, when the shaft is stationary, an elastomer material can ensure a reliable gas seal in order to test for correct assembly. Moreover, the elastic behavior of the elastomer material can lead to a statically sealed bearing against the shaft surface.

In particular, when the sealing portion bears against the shaft, the annular projection and/or the recirculating structure can have in radial section a contour which has a first flank facing the air side and a second flank facing the oil side with the respective flank angles to the axis of the shaft. Moreover, a portion which connects the first flank and the second flank can be configured in an arcuate manner, wherein a radius of the arc is kept as small as possible. Preferably, the flank angle facing the air side can be smaller than the flank angle facing the oil side. For example, the flank angle facing the air side can be between 10° and 40° and the flank angle facing the oil side can be between 40° and 70°. Alternatively, the flank angle facing the air side and the flank angle facing the oil side can be equal.

Preferably, the recirculating structure has at least two discrete elements which in each case are spaced apart from one another over the circumference by a gap. In each case, a chamber, which extends in the circumferential direction from a first minimum spacing to a second minimum spacing, can be defined between the annular projection and a discrete element of the recirculating structure. As a result, a conveying action can be improved. For example, the sealing portion can have 2 to 20 chambers, preferably 3 to 15 chambers, in particular 5 chambers in the circumferential direction. For example, the discrete elements of the recirculating structure can be of equal length. Alternatively, the discrete elements can also have different lengths. Moreover, it is also possible that a first group of discrete elements and a second group of discrete elements are provided, wherein the first group of discrete elements and the second group of discrete elements differ in terms of their respective length. For example, the discrete elements can be arranged such that each second, third, fourth, etc. element, is an element of the second group.

Moreover, the recirculating structure can have a plurality of gaps over the circumference. The gaps can be of equal length in each case. Alternatively, the gaps can also have different lengths. Preferably, the ends of the respective discrete elements which define one respective gap run obliquely to the axis of rotation of the shaft. For example, the end of a discrete element can form an angle of 10° to 60°, preferably 15° to 30°, relative to the circumferential direction. The ends of the discrete elements can be symmetrical or asymmetrical depending on how the recirculating structure itself and the at least one gap is formed. For example, when the at least one gap and thus also the ends of the discrete element are generated by a contour cutter, the ends taper to a point which is asymmetrical due to the different flank angles.

According to a preferred embodiment, the spacing between the annular projection and the recirculating structure runs with a periodic path between a minimum spacing and a maximum spacing. For example, the spacing between the annular projection and the recirculating structure can vary in a zig-zag manner and/or sinusoidal manner. In particular, the profile can be symmetrical relative to its maximum point or minimum point. This has the advantage that a recirculating action is equal in both rotational directions. Moreover, when the sealing portion bears against the shaft, the recirculating structure and/or the annular projection can have a profile in an axial direction which has a periodic path in the axial direction.

Advantageously, when the sealing portion bears against the shaft, both the annular projection and the recirculating structure have a periodic path in the axial direction. For example, the profile of the annular projection can be arranged relative to the profile of the recirculating structure such that a maximum point of the recirculating structure, i.e. a region of the recirculating structure which is closest to the oil side, is arranged above a minimum point of the annular projection, i.e. a region of the annular projection which is closest to the air side, or that a minimum point of the recirculating structure, i.e. a region of the recirculating structure which is furthest away from the oil side, is arranged above a maximum point of the annular projection, i.e. a region of the annular projection which is furthest away from the air side. As a result, it can be ensured that a region is provided in which the spacing between the annular projection and the recirculating structure is as small as possible in order to ensure a good recirculating action through the gap.

Moreover, when the sealing portion bears against the shaft, the annular projection can have a profile in an axial direction which has at least one maximum point and at least one minimum point, wherein the maximum point is closer to the oil side than the minimum point, and wherein the at least one maximum point of the annular projection is arranged in the at least one gap of the recirculating structure. As a result, a part of the annular projection can protrude through the gap so that a conveying action of the oil back to the oil side is improved.

According to a further preferred exemplary embodiment, the sealing portion has a second recirculating structure on the oil side, wherein the second recirculating structure and the annular projection and/or the second recirculating structure and the first recirculating structure are arranged at a variable spacing from one another so that a spacing between the annular projection and the second recirculating structure and/or between the second recirculating structure and the first recirculating structure is varied between a minimum spacing and a maximum spacing, and wherein the second recirculating structure has at least one gap which is arranged in a region of the minimum spacing. This makes it possible to improve further the recirculating action and to reduce the risk of leakage.

Preferably, when the sealing portion bears against the shaft, the second recirculating structure has a profile in an axial direction so that the spacing between the second recirculating structure and the annular projection and/or the first recirculating structure runs between a minimum spacing and a maximum spacing. Moreover, the profile of the second recirculating structure can be equal to or different from the profile of the first recirculating structure. In particular, the profile of the second recirculating structure in the axial direction can be a straight line, a zig-zag profile, a sinusoidal profile or a combination thereof. If the profile of the second recirculating structure has a periodic path, the profile of the second recirculating structure can be symmetrical relative to its maximum point or minimum point. This has the advantage that the recirculating action is equal in both rotational directions.

According to a further preferred embodiment, the seal element has a first group of conveying elements which are arranged on the air side of the annular projection and which extend at an angle to the circumferential direction, and a second group of conveying elements which are arranged on the air side of the annular projection and which extend at the angle but with an opposing orientation to the circumferential direction. For example, the angle of the conveying elements can be between 5° and 30° relative to the circumferential direction. This has the advantage that oil which is located on the air side of the annular projection can be conveyed back to the oil side so that the risk of leakage can be further reduced.

Preferably, the conveying elements of the first group and the conveying elements of the second group can alternate in the circumferential direction. For example, in each case a conveying element of the first group can be arranged directly adjacent to a conveying element of the second group. Moreover, the conveying elements of the first group and the conveying elements of the second group can be arranged in a region in which the spacing between the annular projection and the recirculating structure is at a maximum.

Further advantages and advantageous embodiments are specified in the description, the drawings and the claims. In particular, the combination of features specified in the description and in the drawings are purely by way of example so that the features can also be present individually or combined differently.

The invention is intended to be described in more detail hereinafter with reference to the exemplary embodiments shown in the drawings. The exemplary embodiments and the combinations shown in the exemplary embodiments are purely by way of example and are not intended to limit the protected scope of the invention. This protected scope is defined solely by the dependent claims.

### BRIEF DESCRIPTION OF THE DRAWINGS

FIG. 1 is a schematic sectional view through a radial shaft seal element according to a first embodiment of the present disclosure.

FIG. 2 is a detail view of region II in FIG. 1.

FIG. 3 is a detail view of region III in FIG. 1.

FIG. 4 is a detail view of region IV in FIG. 1.

FIG. 5 is a detail of a recirculating structure of a radial shaft seal element according to a second embodiment of the present disclosure.

FIG. 6 is a schematic sectional view through a radial shaft seal element according to a third embodiment of the present disclosure.

FIG. 7 is a schematic sectional view through a radial shaft seal element according to a fourth embodiment of the present disclosure.

FIG. 8 is a schematic sectional view through a radial shaft seal element according to a fifth embodiment of the present disclosure.

FIG. 9 is a detail view of region IX in FIG. 8.

### DETAILED DESCRIPTION

Elements which are the same or functionally the same are identified by the same reference signs hereinafter.

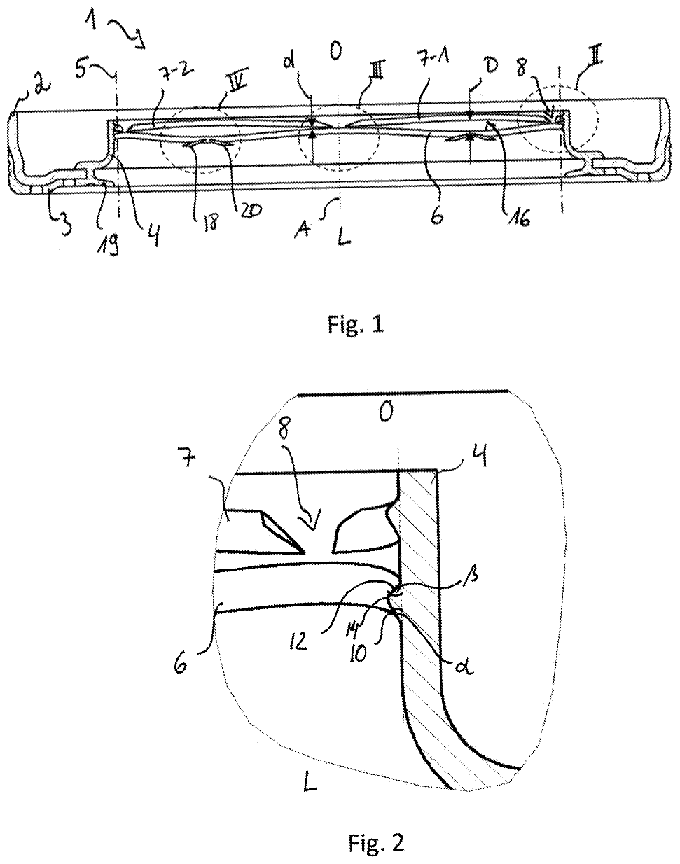

A radial shaft seal element 1 which has a support ring 2 on which a sealing lip 3 is arranged can be seen in FIGS. 1 to 4. In addition to a dust lip 19, the sealing lip 3 has a surface portion 4 which is cylindrical and which is configured to bear against the outer circumference of a shaft 5 (illustrated by dashed-dotted lines). The shaft 5 has an axis A. An oil side O is sealed from an air side L by the seal element 1.

The seal element 1 is intended to operate such that an oil recirculating effect is generated in both rotational directions of the shaft 5. The design of a profiling, which is incorporated on the side of the cylindrically configured surface portion 4 facing the shaft 5, is essential therefor. This profiling is most clearly visible when viewing FIG. 1 and FIG. 2 together. The region of the cylindrical surface portion 4 which is positioned on the surface of the shaft 5 when the seal element 1 is used as intended is shown in FIG. 2.

Accordingly, an annular projection 6 is initially incorporated in the surface portion 4 and namely as a radially inwardly protruding region. The annular projection 6 bears against the shaft 5, wherein the annular projection is arranged in an edge region of the cylindrical surface portion 4 adjacent to the air side L. Moreover, the recirculating structure 7 is incorporated in the surface portion 4, once again as a radially inwardly protruding region which bears against the shaft 5. The recirculating structure 7 is arranged in the other edge region of the cylindrical surface portion 4 adjacent to the oil side O. In other words, the recirculating structure 7 is arranged on the oil side of the annular projection 6. The annular projection 6 may sometimes be referred to as a “first ridge,” and the recirculating structure 7 may sometimes be referred to as a “second ridge.”

As will be appreciated from FIG. 2, the annular projection 6 and the recirculating structure 7 in radial section have a contour with a first flank 10 facing the air side L and a second flank 12 facing the oil side O. The first flank 10 and the second flank 12 have in each case a flank angle α or β relative to the axis A of the shaft 5. The portion 14 which connects the first flank 10 and the second flank 12 is preferably of arcuate configuration, wherein a radius of the arc is kept as small as possible. In particular, the flank angle α can be smaller than the flank angle β. For example, α can be between 10° and 40° and β can be between 40° and 70°.

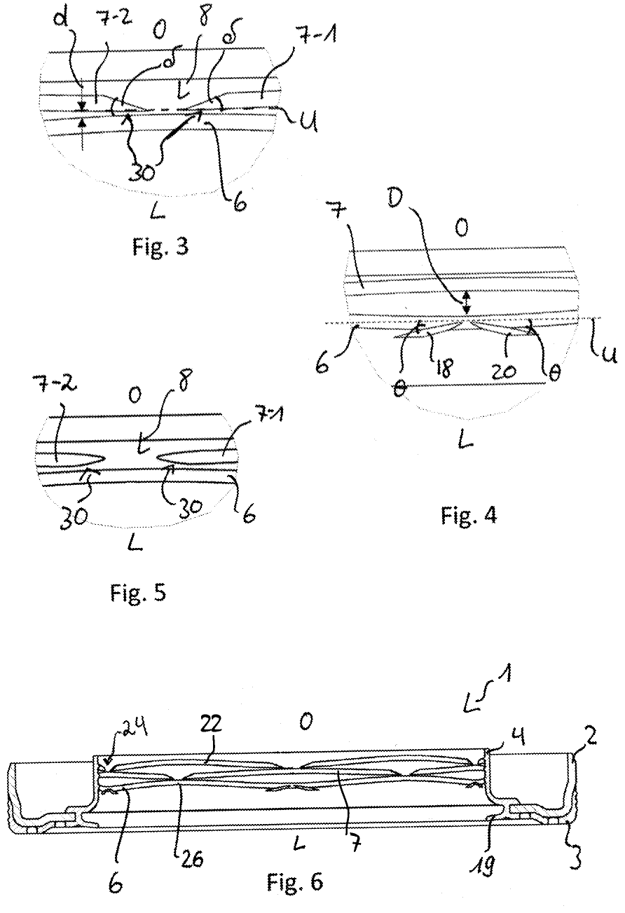

As will be appreciated from FIGS. 1 to 3, the annular projection 6 and the recirculating structure 7 are arranged with a spacing from one another in the axial direction, wherein the spacing between the annular projection 6 and the recirculating structure 7 varies between a minimum spacing d (FIG. 3) and a maximum spacing D (FIG. 4).

A gap 8 is provided in the recirculating structure 7 in the region of the minimum spacing d. In the radial shaft seal element 1 according to the first embodiment, the spacing between the annular projection 6 and the recirculating structure 7 runs with a periodic path, in particular in a sinusoidal manner, wherein both the annular projection 6 and the recirculating structure 7 have a sinusoidal path in the axial direction.

As can be seen in FIG. 1, in the first embodiment the sinusoidal path of the annular projection 6 and the recirculating structure 7 are arranged such that the two profiles are offset to one another by a half amplitude, i.e. maximum point of the recirculating structure 7, i.e. a region of the recirculating structure 7 which is closest to the oil side O is arranged above a minimum point of the annular projection 6, i.e. a region of the annular projection 6 which is closest to the air side L.

As described above, in the region of the minimum spacing d a gap 8 is provided in the recirculating structure 7. In other words, the recirculating structure 7 has a plurality of discrete elements 7-1, 7-2 which in each case are spaced apart from one another over the circumference by a gap 8. As a result, a chamber 16, which extends in the circumferential direction between two regions with a minimum spacing d, is defined between the annular projection 6 and a discrete element 7-1, 7-2. As a result, a conveying action can be improved. For example, between two and twenty chambers 16 can be provided in the circumferential direction.

The number of chambers 16 can be dependent on many factors, such as for example a shaft diameter, the type of oil, etc. The ends 30 of the respective discrete elements 7-1, 7-2 which define one respective gap 8 run obliquely to the axis of rotation A of the shaft 5 in order to improve a recirculating action. For example, the end 30 of a discrete element 7-1, 7-2 can form an angle δ of 10° to 60°, preferably 15° to 30°, in the circumferential direction U.

Provided the shaft 5 is stationary, the chamber 16 between the annular projection 6 and the recirculating structure 7 is filled with oil. As soon as the shaft 5 rotates, the shaft entrains the oil. Due to the variable spacing between the annular projection 6 and the recirculating structure 7, the oil is conveyed in the direction of the region with minimum spacing and thus a gap 8 so that excess oil is removed from the chamber 16.

In order to reduce further the risk of leakage, two groups of conveying elements 18, 20, sometimes referred to as ribs, which are arranged on the air side of the annular projection 6 (FIG. 4) are provided. The first group 18 extends at an angle θ to the circumferential direction U and the second group 20 extends at the same angle θ but with an opposing orientation to the circumferential direction U.

Each conveying element 18, 20 consists of a radially inwardly elevated web structure which is in contact with the shaft 5. As can be seen in FIG. 4, the conveying elements 18 of the first group and the conveying elements 20 of the second group alternate in the circumferential direction and are arranged evenly distributed in pairs over the circumference of the surface portion 4. In order to improve further the recirculating action of the oil, the conveying elements 18, 20 are arranged in a region in which the spacing between the annular projection 6 and the recirculating structure 7 is at a maximum.

FIG. 5 shows a detail of a recirculating structure 7 of a radial shaft seal element 1 according to a second embodiment. The radial shaft seal element 1 according to the second embodiment corresponds substantially to the radial shaft seal element 1 according to the first embodiment, with the difference that the gaps 8 in the recirculating structure 7 are incorporated retroactively in the recirculating structure 7. In other words, the recirculating structure 7 is initially formed as continuous structure on the sealing portion 4. Then the gaps 8 are configured in the recirculating structure 7 in a post-machining step. In the radial shaft seal element 1 according to the second embodiment, the gap is generated by a contour cutter, whereby the ends 30 taper to a point, which is asymmetrical due to the different flank angles, as can be seen in FIG. 5.

FIG. 6 shows a radial shaft seal element 1 according to a third embodiment. The radial shaft seal element 1 according to the third embodiment differs from the radial shaft seal element 1 according to the first embodiment in that the sealing portion or surface portion 4 on the oil side has a second recirculating structure 22. In FIG. 6 the second recirculating structure 22 has a variable spacing from the annular projection 6 and from the first recirculating structure 7. The second recirculating structure 22 also has a plurality of gaps 24 which in each case are provided in the region of the minimum spacing d between the first recirculating structure 7 and the second recirculating structure 22.

In FIG. 6 both the annular projection 6 and the first recirculating structure 7 and the second recirculating structure 22 run in a sinusoidal manner. The annular projection 6 and the first recirculating structure 7 and the first recirculating structure 7 and the second recirculating structure 22 are offset to one another by a half period. In other words, the annular projection 6 and the second recirculating structure 22 run parallel to one another. In FIG. 5 all of the sinusoidal profiles of the annular projection 6, the first recirculating structure 7 and the second recirculating structure 22 have the same amplitude in each case. Alternatively, the sinusoidal profiles of the annular projection 6, the first recirculating structure 7 and the second recirculating structure 22 can also have different amplitudes. It is also possible that the sinusoidal profiles of the annular projection 6, the first recirculating structure 7 and the second recirculating structure 22 have different periods so that the second recirculating structure 22 has a period which is twice as large as the first recirculating structure 7.

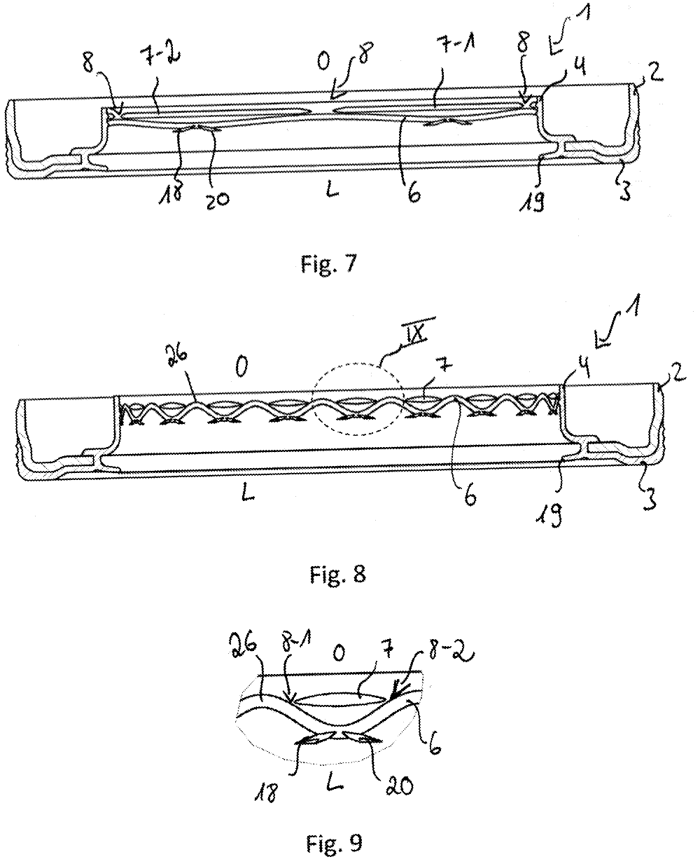

FIG. 7 shows a radial shaft seal element 1 according to a fourth embodiment. The radial shaft seal element 1 according to the fourth embodiment differs from the radial shaft seal element 1 according to the first embodiment in that the recirculating structure 7 is configured as a straight line in the axial direction, while the annular projection 6 runs in a sinusoidal manner. In this case, the variation of the spacing between the annular projection 6 and the recirculating structure 7 is generated solely by the periodic profile of the annular projection 6 in the axial direction. As in the radial shaft seal element 1 according to the first embodiment, the gaps 8 are arranged in the regions in which the axial spacing is at a minimum between the annular projection 6 and the recirculating structure 7.

FIGS. 8 and 9 show a radial shaft seal element 1 according to a fifth embodiment. The radial shaft seal element 1 according to the fifth embodiment differs from the radial shaft seal element 1 according to the first embodiment in that the profile of the annular projection 6 in the axial direction is in the manner of a zig-zag and the profile of the recirculating structure 7 is configured as a straight line in the axial direction. The profile of the annular projection 6 is arranged such that the maximum points 26 of the annular projection 6 pass through the gaps 8 of the recirculating structure 7 so that the gap 8 has a first part 8-1 and a second part 8-2.

In summary, a radial shaft seal element 1 which has an equal fluid recirculating effect in both rotational directions of the shaft 5 is provided. Moreover, the described radial shaft seal element 1 is suitable, in particular, for use at high rotational speed. As the radial shaft seal element 1 can be used in both rotational directions, depending on a preferred rotational direction of a corresponding application, it is not necessary to provide a specific seal element in storage. As a result, storage space and thus costs can be reduced.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved radial seal elements.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

1 Radial shaft seal element
2 Support ring
4 Sealing portion
5 Shaft
6 Annular projection
7 First recirculating structure
8 Gap
10 First flank
12 Second flank
14 Portion
16 Chamber
18, 20 Conveying element
22 Second recirculating structure
24 Gap
26 Maximum point
30 End
A Axis of rotation
d Minimum spacing
D Maximum spacing
U Circumferential direction
α, β Flank angle
δ Angle
θ Angle

What is claimed is:

1. A radial shaft seal element comprising:
a support ring,
at least one seal body mounted on the support ring, the seal body including a sealing portion configured to assume a cylindrical shape and bear against a shaft to be sealed and to separate an air side of the radial shaft seal from an oil side of the radial shaft seal,
wherein the seal body includes a distal end at the oil side,
wherein the sealing portion includes an annular projection configured to bear against the shaft around a circumference of the shaft and a first recirculating structure between the annular projection and the distal end,
wherein an axial spacing between the annular projection and the first recirculating structure varies between a minimum and a maximum, and
wherein the first recirculating structure has at least one gap.

2. The radial shaft seal according to claim 1,
wherein the at least one gap is located at a region of the minimum spacing.

3. The radial shaft seal element according to claim 2,
wherein the first recirculating structure comprises at least two discrete elements each having a first element end spaced circumferentially from a second element end,
wherein the first element end of a first one of the at least two discrete elements is spaced from the second element end of a second one of the at least two discrete elements by one of the at least one gap, and
wherein a chamber is defined between an adjacent pair of the at least one gap by the first one of the at least two discrete elements and the annular projection.

4. The radial shaft seal element according to claim 3,
wherein the first one of the at least two discrete elements has a first length and the second one of the at least two discrete elements has a second length and wherein the first length is the same as or different than the second length.

5. The radial shaft seal element according to claim 2,
wherein the axial spacing varies periodically.

6. The radial shaft seal element according to claim 2,
wherein the first recirculating structure follows a zig-zag or sinusoidal path.

7. The radial shaft seal element according to claim 6,
wherein when the sealing portion bears against the shaft, the first recirculating structure and/or the annular projection has in an axial direction a profile which has at least one maximum point and at least one minimum point relative to the distal end.

8. The radial shaft seal element according to claim 1,
wherein at least one portion of the first recirculating structure extends into the at least one gap.

9. The radial shaft seal element according to claim 2,
including a second recirculating structure between the first recirculating structure and the distal end,
wherein an axial spacing between the second recirculating structure and the first recirculating structure varies between a minimum spacing and a maximum spacing, and
wherein the second recirculating structure includes a gap at the minimum spacing between the second recirculating structure and the first recirculating structure.

10. The radial shaft seal element according to claim 9,
wherein the axial spacing between the second recirculating structure and the first recirculating structure varies periodically.

11. Radial shaft seal element according to claim 10,
wherein a profile of the second recirculating structure is the same as or different from a profile of the first recirculating structure.

12. The radial shaft seal element according to claim 9,
wherein the second recirculating structure follows a straight line path, a zig-zag path, a sinusoidal path or a combination thereof.

13. The radial shaft seal element according to claim 2,
including a first set of conveying elements on the air side of the annular projection extending at a first angle to a circumferential direction, and a second set of conveying elements extending at a second angle to the circumferential direction, the second angle being equal to but opposite the first angle.

14. The radial shaft seal element according to claim 13,
wherein conveying elements of the first set of conveying elements and the conveying elements of the second set of conveying elements alternate in the circumferential direction.

15. The radial shaft seal element according to claim 13,
wherein the first set of conveying elements and the second set of conveying elements are located at a region at which the axial spacing between the annular projection and the first recirculating structure is at a maximum.

16. The radial shaft seal element according to claim 13,
wherein the first set of conveying elements comprise a first set of conveying ribs and the second set of conveying elements comprise a second set of conveying ribs.

17. The radial shaft seal element according to claim 16,
wherein the first recirculating structure comprises at least two ridges separated by the at least one gap.

18. The radial shaft seal element according to claim 16,
wherein the first set of conveying ribs and the second set of conveying ribs are located at a region at which the axial spacing between the annular projection and the first recirculating structure is at a maximum.
